(19) United States
(12) Patent Application Publication
(10) Pub. No.: US 2025/0372687 A1
(43) Pub. Date: Dec. 4, 2025

(54) METHOD FOR LAMINATING STRIPS OF MATERIAL FOR THE PRODUCTION OF ELECTRICAL ENERGY STORAGE DEVICES AND RELATED MACHINE

(71) Applicant: MANZ ITALY S.R.L., SASSO MARCONI (BO) (IT)

(72) Inventors: Nicolò Minafra, SASSO MARCONI (BO) (IT); Francesco Pagani, SASSO MARCONI (BO) (IT)

(73) Assignee: MANZ ITALY S.R.L., SASSO MARCONI (BO) (IT)

(21) Appl. No.: 18/875,517

(22) PCT Filed: Jun. 20, 2023
(86) PCT No.: PCT/IB2023/056373

§ 371 Date: Dec. 16, 2024

(30) Foreign Application Priority Data
Jun. 24, 2022 (IT) 102022000013399

(51) Int. Cl. H01M 10/04

(52) U.S. Cl. CPC H01M 10/0404

(57) ABSTRACT

Method for laminating strips of material, in particular for the production of electrical energy storage devices, the strips comprising a first separator strip and at least a first electrode strip, the first separator strip comprising a first face and a second face, the method comprising the sequential steps of: conveying the first separator strip along a feeding path in a first direction; heating at least the first face of the first separator strip, the first face of the first separator strip being configured to face a respective face of the first electrode strip; introducing the first separator strip and the first electrode strip in a lamination unit; and cold laminating, via the lamination unit, the first separator strip and the first electrode strip together.

### CROSS-REFERENCE TO RELATED APPLICATIONS

This Patent Application claims priority from Italian Patent Application No. 102022000013399 filed on Jun. 24, 2022, the entire disclosure of which is incorporated herein by reference.

### TECHNICAL FIELD

The present invention relates to a method for laminating strips of material for the production of electrical energy storage devices and a related machine.

In particular, the present invention is advantageously, but not exclusively, applied to the production of rechargeable batteries, more in particular to the production of planar batteries, for example in metal can or enveloped (commonly called pouch), to which the following description will explicitly refer without thereby losing generality.

### STATE OF THE ART

Automatic machines for the production of electrical energy storage devices are known, and in particular rechargeable batteries or capacitors.

Rechargeable batteries usually comprise two electrode layers (anode and cathode) and at least two separator layers superimposed on each other and alternated according to an electrode-separator-electrode-separator model. In general, rechargeable batteries are cylindrical or planar.

Automatic machines known for the production of cylindrical batteries feed and convey electrode strips and separator strips along different feeding paths which all converge towards a rotating winding unit, which is configured to retain and wind, about an elongated-shaped support, the electrode strips and the separator strips superimposed on each other according to the aforementioned electrode-separator-electrode-separator model, so as to form a cylindrical winding.

Automatic machines known for the production of planar batteries often feed and convey electrode strips and separator strips along different feeding paths which all converge towards a lamination unit, inside which the strips are laminated together so as to be superimposed according to the aforementioned electrode-separator-electrode-separator model (i.e., to form single cells, but also possibly by forming dual cells or half cells).

Typically, during lamination, the electrode and separator strips are arranged between two additional protection layers, which are also strip-shaped. Such protection layers are configured to protect both the lamination rollers and electrode and separator strips inside the lamination unit and are usually removed at the exit from the latter.

More specifically, the automatic machines for the production of planar batteries comprise a feeding assembly provided with as many reels as the electrode strips and the separator strips for feeding and conveying the electrode strips and the separator strips along the respective feeding paths and, for each electrode strip, and thus for each electrode (cathode and anode) of the battery to be produced, a cutting and conveying apparatus adapted to singularize the electrode strip, that is, to sequentially cut the electrode strip at respective transversal cutting sections, so as to obtain strip portions, known as plates or blanks, defining the electrodes of each of the cells that will subsequently compose the planar battery. The cut strip portions are fed to a pair of input rollers of the lamination unit, in a synchronous manner with the separator strips.

Downstream of the lamination unit, in some cases, the multilayer strip, consisting of the two electrode strips cut in subsequent portions and the two still continuous separator strips, is cut transversely so as to obtain a sequence of planar cells separated from each other, which will be subsequently stacked and boxed or enveloped so as to obtain a planar battery. In other cases, instead, the multilayer strip is wound about a flat pin so as to accurately superimpose the electrode strip portions forming a planar winding.

Normally, the cutting and conveying apparatus comprises a gripping assembly and a cutting assembly. The electrode strip is conveyed along a portion of the relative feeding path up to the gripping assembly which is linearly movable with reciprocating motion parallel to the electrode strip and comprises two grippers arranged on opposite sides of the electrode strip which close retaining the strip, once the linear speed of the electrode strip has been reached by means of the reciprocating motion. Once the grippers have gripped the electrode strip, the cutting assembly, comprising a blade member which is movable as well with reciprocating motion integrally with the gripping assembly, cuts the electrode strip upstream of the gripping assembly with respect to the advancement direction of the strip.

In particular, the aforementioned cutting and conveying apparatus comprises a slide which carries the gripping assembly and the cutting assembly and is linearly and cyclically movable with reciprocating motion between a retracted position, spaced from the lamination unit, and an advanced position, close to the lamination unit for feeding to the latter one electrode strip portion at a time. Between these two positions, the apparatus reaches the linear advancement speed of the electrode strip so as to grip it and cut it without causing undesired tensioning or stretching therein.

Once the cutting of the electrode strip has been completed, the cutting and conveying apparatus completes its linear advancement motion towards the advanced position, slowing down and feeding (or “delivering”) the electrode strip portion that has been cut to the input rollers of the lamination unit.

The lamination unit receives the separator strips and electrode strips, and hot laminates them together (by heating the lamination rollers at temperatures usually higher than 100° C.) to obtain the multilayer strip according to the aforementioned electrode-separator-electrode-separator model.

Alternatively or additionally, the lamination unit receives the whole aforementioned multilayer strip (possibly together with outer protective films) from a preheating module, which is however subject to a high energy consumption and does not address the issues described below.

The above-described process, in particular the lamination process, has several drawbacks which are set forth below.

Managing the aforementioned protective layers requires a dedicated system, with a clear increase in costs, dimensions, and energy. Furthermore, such dedicated system collects static electricity and thus an additional system to suppress it is necessary, with a further increase in costs, dimensions, and energy, as well as safety-related issues.

The separator, typically made of polymeric material, must be coated with ceramic material particles to counteract the known dendrite problem and generally improve mechanical strength.

The electrodes (anode and cathode) react differently when heated during lamination, since they are made of different materials with respective thermal expansion coefficients which are different from one another. Due to the flexible structure of the separator, these differences usually cause the multilayer material to bend. In this way, the electrodes have different deviations and therefore they bend, the separator is subject to stresses to compensate such deviations, and the multilayer strip has a concavity which cannot be easily eliminated later (due to the dust level of the materials composing the electrodes, which are at risk of cracking) and therefore entails a severe degradation of the end product performance and generally a difficult and long setup of the automatic machine for the production of storage devices.

### OBJECT AND SUMMARY OF THE INVENTION

The object of the present invention is to carry out a method for laminating strips of material for the production of electrical energy storage devices and a related machine, which are at least partially exempt from the above-described drawbacks and, at the same time, are easy and cost-effective to manufacture.

In accordance with the present invention, a method for laminating strips of material for the production of electrical energy storage devices and a related machine are provided.

The claims describe preferred embodiments of the present invention forming an integral part of the present invention.

### BRIEF DESCRIPTION OF THE DRAWINGS

In order to better understand the present invention, a preferred embodiment is described in the following, by way of a non-limiting example and with reference to the accompanying drawings, wherein:

FIG. 1 is a schematic view, with parts removed for clarity, of part of an automatic machine for the production of electrical energy storage devices manufactured according to the present invention;

FIG. 2 is a schematic view of a variation of the machine of FIG. 1;

FIG. 3 is a schematic view, with parts removed for clarity, of an alternative embodiment of the machine of FIG. 1; and

FIG. 4 is a schematic view of a variation of the machine of FIG. 3.

### DETAILED DESCRIPTION

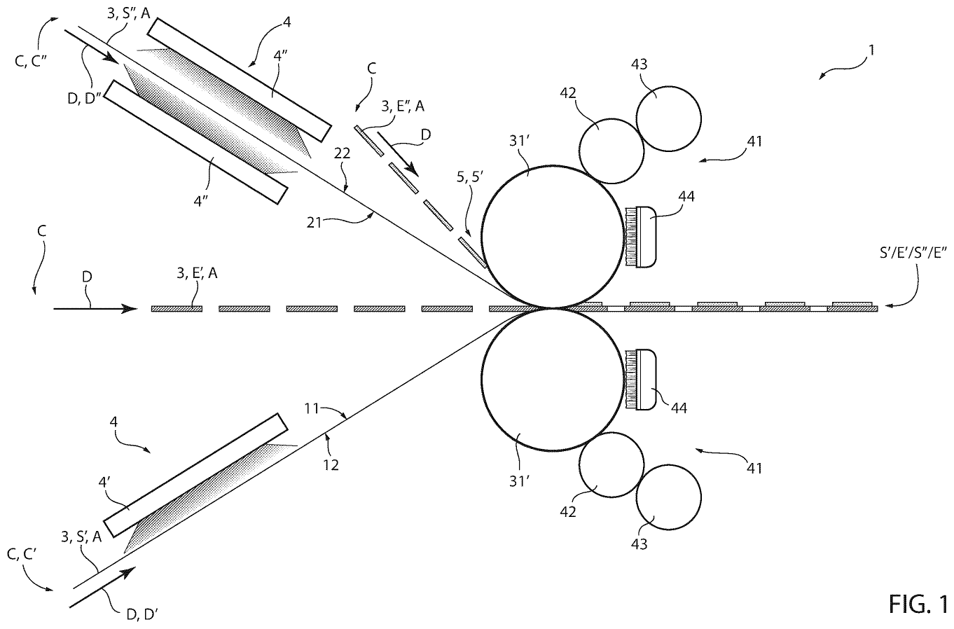

With reference to FIG. 1, reference number 1 indicates an automatic machine for the production of electrical energy storage devices, in particular rechargeable batteries, more specifically planar rechargeable batteries enveloped or in metal can.

The machine 1 comprises a feeding unit (not illustrated) for feeding at least one strip 3 of material for the production of the electrical energy storage devices along a respective feeding path A and in an advancement direction D, at least one conveyor unit C arranged downstream of the feeding unit with respect to the advancement direction D, heating means 4 arranged along the advancement path A, at least one lamination unit 5 arranged downstream of the heating means 4 with respect to the advancement direction D and configured to receive the strip 3 and cold laminate it with at least another strip 3 of material for the production of the electrical energy storage devices. Optionally, the conveyor unit C comprises a cutting unit configured to sequentially cut the respective strip 3 to determine the sequential separation of subsequent portions thereof, as described in the applications IT102021000014459, IT102021000015245, IT102021000021578. According to these non-limiting embodiments (FIGS. 1-4), such strip 3 reaches the lamination unit 5 in cut form, that is, as a sequence of portions of the same. According to other non-limiting embodiments (not illustrated), the strips 3 can be laminated by the lamination unit 5 also seamlessly, being cut subsequently during the production process or not being cut at all and used for the forming of planar or cylindrical windings (known and not further detailed).

In particular, the feeding unit is configured to feed a plurality of strips 3, initially wound in reels, along respective feeding paths A and respective advancement directions D.

It is specified that the advancement direction D indicates, in the present description, a direction parallel to the relative feeding path A in every point thereof, and substantially extending from the feeding unit to the lamination unit 5.

The feeding unit is configured to feed at least a first separator strip 3, S′ and at least a first electrode strip 3, E′, for example one of an anode strip and a cathode strip. Both the first separator strip 3, S′ and the first electrode strip 3, E′ have two opposite faces. In particular, the first separator strip 3, S′ has a first face 11 and a second face 12. The first face 11 of the first separator strip 3, S′ is configured to face a respective face of the first electrode strip 3, E′ to which it will be coupled following lamination.

Advantageously but not necessarily, the feeding unit is configured to feed at least a second separator strip 3, S″ and at least a second electrode strip 3, E″, for example the other of an anode strip and a cathode strip relative to the first electrode strip 3, E′. Both the second separator strip 3, S″ and the second electrode strip 3, E″ have two opposite faces.

In particular, the second separator strip 3, S″ has a first face 21 and a second face 22. The first face 21 of the second separator strip 3, S″ is configured to face a respective face of the first electrode strip 3, E′, to which it will be coupled during lamination (making them integral to each other). The second face 22 of the second separator strip 3, S″ is configured to face a respective face of the second electrode strip 3, E″, to which it will be coupled during lamination (making them integral to each other).

In some non-limiting cases, the first separator strip 3, S′ and the second separator strip 3, S″ are separators provided with (coated with or soaked with or themselves) solid-state electrolyte (SSE), for example inorganic solid electrolyte (ISE), solid polymer electrolyte (SPE), and composite polymer electrolyte (CPE).

In other non-limiting cases, the first separator strip 3, S′ and the second separator strip 3, S″ are separators provided with (coated with or soaked with or themselves) quasi solid-state electrolyte (QSSE) or a gel, for example, but not in a limiting way, by using the same polymers as the solid-state polymer electrolytes (PEO, PAN, PMMA, PVDF-HFP, etc.), but synthesized with greater porosity to easily allocate organic solvents such as ethylene carbonate (EC), propylene carbonate (PC), diethyl carbonate (DEC), dimethyl carbonate (DMC), with plasticizing effect.

Preferably, but not in a limiting way, the first separator strip 3, S′ and the second separator strip 3, S″ are made of polymeric material (comprising polyethylene or polypropylene, for example). In particular, they comprise a thermoplastic polymer, for example PVDF or acrylate. Furthermore, they may, but not necessarily, have ceramic particles on their surface.

According to the non-limiting embodiments of the accompanying figures, the feeding path A of the first separator strip 3, S′ extends, along a first direction D′, from the respective reel to the lamination unit 5, passing through a first conveyor unit C′. Similarly, the feeding path A of the second separator strip 3, S″ extends, along a second separator direction D″, from the respective reel to the lamination unit 5, passing through a second conveyor unit C″.

According to the non-limiting embodiments of the accompanying figures, the feeding path A of the first electrode strip 3, E′ and the second electrode strip 3, E″ extends from the respective reel to the lamination unit 5, passing through a respective first conveyor unit C which optionally comprises a respective cutting unit configured to sequentially cut the respective electrode strip 3 E′, E″ to determine the sequential separation of subsequent portions thereof.

Preferably, but not in a limiting way, the heating means 4 are selected from the group comprising heating plates, resistance heaters, infrared heaters, microwave heaters, laser heaters, ultrasonic heaters. Conveniently, the heating means 4 can be of a single type or a combination of types among those noted above.

The heating means 4 comprise first heating means 4′ operatively interposed between the first conveyor unit C′ of the first separator strip 3, S′ and a first lamination unit 5′.

The first heating means 4′ are configured to heat at least the first face 11 of the first separator strip 3, S′.

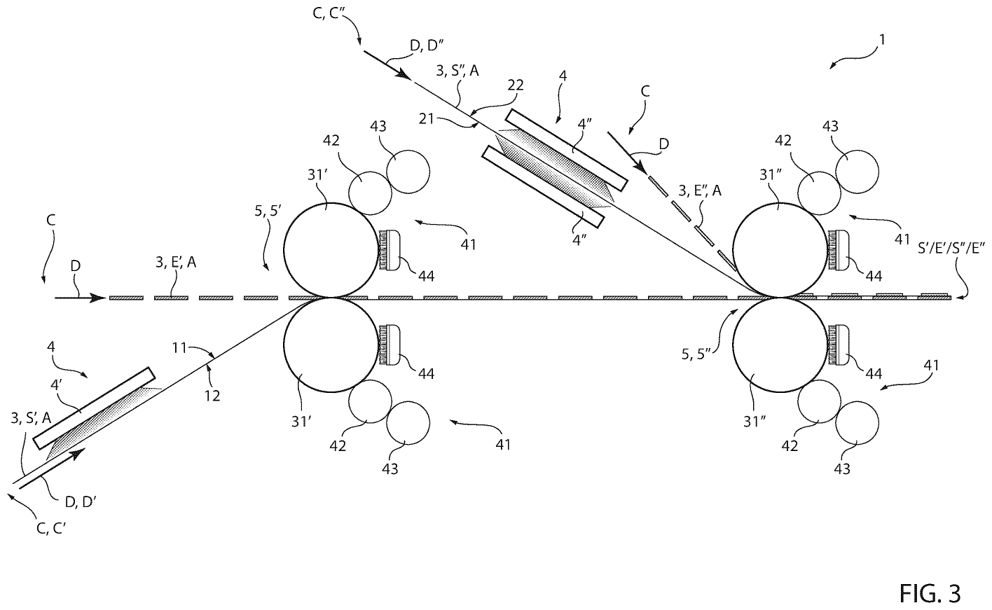

In some non-limiting cases, the first heating means 4′ (FIGS. 1 and 3) are configured to exclusively heat the first face 11 of the first separator strip 3, S′.

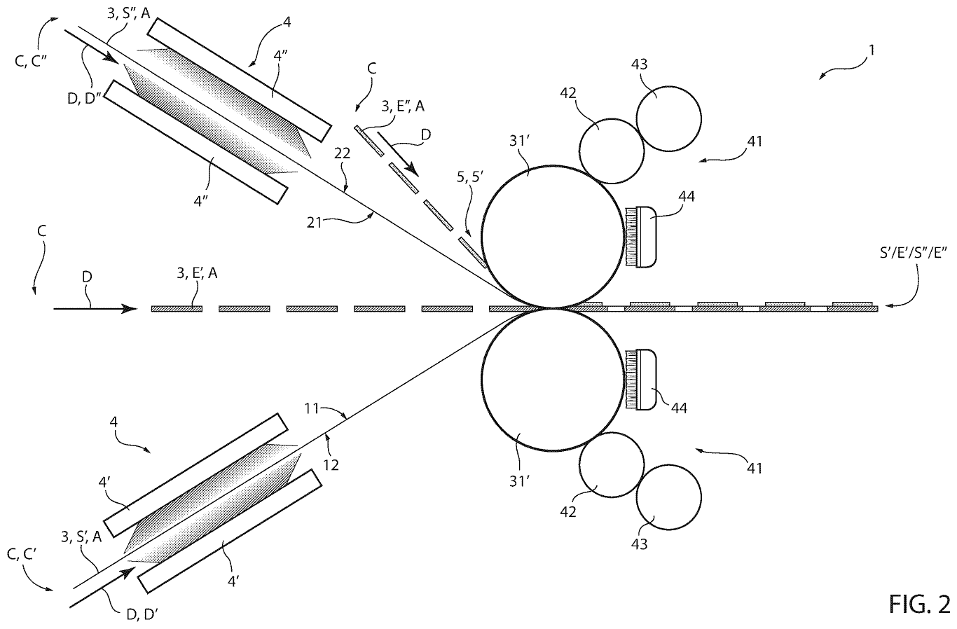

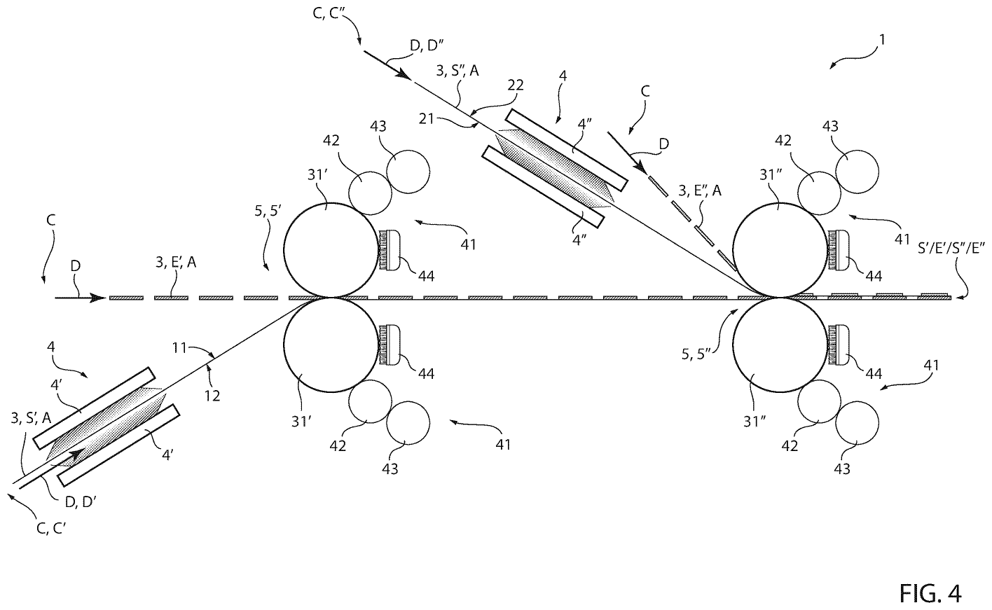

In other non-limiting cases, the first heating means 4′ (FIGS. 2 and 4) are configured to heat both the first face 11 and the second face 12 of the first separator strip 3, S′.

Advantageously, first lamination unit 5′ is the configured to cold laminate the first separator strip 3, S′ and the first electrode strip 3, E′ together.

In the present description, it should be noted that “cold” lamination means that most of the heating of the strips 3, in particular separator strips S′, S″, occurs in a step prior to lamination; in particular, but not in a limiting way, at a distance greater than 50 mm, preferably less than 1000 mm from the lamination unit 5, in particular less than 500 mm, more precisely, but not in a limiting way, between 100 mm and 500 mm.

Preferably, but not in a limiting way, “cold” lamination means laminating at a temperature lower than 80° C., in particular lower than 70° C. (i.e., in use, the rollers 31 of the lamination unit 5 do not exceed such temperature). In other words, the separator strips 3, S′, S″ are individually heated, whereas the electrode strips 3, E′, E″ are maintained room temperature until they reach the lamination unit 5′ (in which they are in contact with the separator strips 3, S′, S″).

Preferably, but not in a limiting way, the heating means 4′, 4″ are configured to heat the separator strips 3, S′, S″ at a temperature between 25° C. and 120° C., in particular at a temperature between 50° C. and 100° C., preferably between 65° C. and 85° C.

In some non-limiting and not illustrated cases, at least one electrode strip 3, E′, E″ is also individually heated by dedicated heating means (potentially similar to the means 4′, 4″) upstream of the lamination unit 5.

In particular, the first lamination unit 5′ comprises two lamination rollers 31′ opposite to each other and configured to receive at least the first separator strip 3, S′ and the first electrode strip 3, E′. More in particular, the feeding paths A of the first separator strip 3, S′ and the first electrode strip 3, E′ converge at the lamination rollers 31′, which are arranged on opposite sides of the feeding path A.

As such, the first electrode strip 3, E′ is not heated by the first heating means 4′; in particular, its own feeding path A does not pass through the first heating means 4′. Specifically, and preferably, the electrode strip E′ is never heated by the reel by which it is unwound to the (included) lamination process.

Downstream of the first lamination unit 5′, the first separator strip 3, S′, and the first electrode strip 3, E′ are (integrally) coupled together.

Advantageously but not necessarily, the heating means 4 comprise second heating means 4″ configured to heat the first face 21 of the second separator strip 3, S″ and to heat the second face 22 of the second separator strip 3, S″ .

In particular, the first face 21 of the second separator strip 3, S″ may be heated prior to, simultaneously with (FIGS. 1-4) or subsequently to the second face 22 of the separator strip 3, S″, for example by conveniently adjusting the relative position of the second heating means 4″.

According to a non-limiting embodiment (FIGS. 1 and 2), the first lamination unit 5′ is configured to cold laminate the first electrode separator strip 3, S′, the first electrode strip 3, E′, the second separator strip 3, S″, the second electrode strip 3, E″ together.

According to this embodiment, the lamination rollers 31′ of the first lamination unit 5′ are configured to receive, in addition to the first separator strip 3, S′ and the first electrode strip 3, E′, the second separator strip 3, S″ and the second electrode strip 3, E″ as well.

In particular, the feeding paths A of the first separator strip 3, S′, the first electrode strip 3, E′, the second separator strip 3, S″, and the second electrode strip 3, E″ converge at the lamination rollers 31′. As such, the second heating means 4″ are operatively interposed (and preferably separated from one another) between the second conveyor unit C″ of the second separator strip 3, S″ and the first lamination unit 5′.

Furthermore, in a non-limiting way, the second electrode strip 3, E″ is not heated by the second heating means 4″, in particular its own feeding path A does not pass through the second heating means 4″. Specifically, and preferably, the electrode strip E′ is never heated by the reel by which it is unwound to the (included) lamination process.

Downstream of the first lamination unit 5′, the first separator strip 3, S′, the first electrode strip 3, E′, the second separator strip 3, S″, and the second electrode strip 3, E″ are (integrally) coupled together in this order, thus forming a multilayer strip S′/E′/S″/E″. Obviously, which of the electrodes E′, E″ is the anode and the cathode may vary according to the storage device which is intended to be produced.

According to an alternative and non-limiting embodiment (FIGS. 3 and 4), the machine 1 further comprises a second lamination unit 5″ separated from the first lamination unit 5′ and arranged downstream of the same.

According to such embodiment, the second lamination unit 5″ is configured to cold laminate the second separator strip 3, S″ and the second electrode strip 3, E″, and the previously laminated (and thus coupled) strips 3 by the first lamination unit 5′.

In particular, the second lamination unit 5″ comprises two lamination rollers 31″ opposite to each other and configured to receive the first electrode separator strip 3, S′, the first electrode strip 3, E′, the second separator strip 3, S″ and the second electrode strip 3, E″. More in particular, the feeding paths A of the second separator strip 3, S″ and the second electrode strip 3, E″ converge at the lamination rollers 31″, which are arranged on opposite sides of the feeding path A.

As such, preferably, the second heating means 4″ are operatively interposed between the second conveyor unit C″ of the second separator strip 3, S″ and the second lamination unit 5″.

Furthermore, in a non-limiting way, the second electrode strip 3, E″ is not heated by the second heating means 4″, in particular, its own feeding path A does not pass through the second heating means 4″. Specifically, and preferably, the electrode strip E″ is never heated by the reel by which it is unwound to the (included) lamination process, i.e., to the second lamination unit 5″.

In this case, downstream of the second lamination unit 5″, the first separator strip 3, S′, the first electrode strip 3, E′, the second separator strip 3, S″, and the second electrode strip 3, E″ are coupled together in this order, thus forming the multilayer strip S′/E′/S″/E″.

Preferably, each lamination roller 31′, 31″ comprises a non-stick or easy release coating, for example CrC, CrC-Teflon, hard coatings, or resins.

Advantageously but not necessarily, the machine 1 further comprises at least a cleaning system 41 of the lamination rollers 31′, 31″.

Conveniently, but not in a limiting way, each lamination roller 31′, 31″ has a respective cleaning system 41 associated.

In particular, each cleaning system 41 comprises at least an elastomeric roller 42 and/or an adhesive roller 43 and/or a cleaning brush 44.

Conveniently, but not in a limiting way, the elastomeric roller 42 is operatively arranged downstream of the respective lamination roller 31′, 31″, and the adhesive roller 43 is operatively arranged downstream of the respective elastomeric roller 42, whereas the cleaning brush 44 is operatively arranged downstream of the respective lamination roller 31′, 31″.

Preferably, the elastomeric roller 42 and the cleaning brush 44 directly act on the lamination roller 31′, 31″ to which they are associated to remove potential residues from its surface. Since the elastomeric roller 42 tends to accumulate such residues onto its own surface, such residues can be removed via the respective adhesive roller 43, which directly acts on the elastomeric roller 42 to which it is associated, and/or periodically replace the elastomeric roller 42.

The present invention also relates to a method for laminating strips of material, in particular for the production of electrical energy storage devices, comprising the steps of:
a) conveying the first electrode separator strip 3, S′ along a feeding path A in a first direction D′;
b) heating at least the first face 11 of the first separator strip 3, S′;
c) introducing the first electrode strip 3, E′; and
d) cold laminating the first separator strip 3, S′ and the first electrode strip 3, E′ together.

Conveniently, such steps are performed sequentially. As such, unlike the first separator strip 3, S′, the first electrode strip 3, E′ is not heated before being cold laminated.

Advantageously but not necessarily, the method further comprises the steps of:
e) conveying the second separator strip 3, S″ along a feeding path A in a second direction D″;
f) heating the first face 21 of the second separator strip 3, S″;
g) heating the second face 22 of the second separator strip 3, S″; and
h) cold laminating the second separator strip 3, S″ and the second electrode strip 3, E″ together.

Conveniently, the step of heating the first face 21 of the second separator strip 3, S″ is prior to, simultaneous with or subsequent to the step of heating the second face 22 of the second separator strip 3, S″ .

The step of cold laminating the first separator strip 3, S′ and the first electrode strip 3, E′ together is conveniently carried out in the first lamination unit 5′.

In the case where the step of cold laminating the second separator strip 3, S″ and the second electrode strip 3, E″ together is also present, such step is carried out in the first lamination unit 5′ (FIGS. 1 and 2) or the second lamination unit 5″ (FIGS. 3 and 4).

According to an alternative embodiment not illustrated, the second separator strip 3, S″ and the second electrode strip 3, E″ are hot laminated together, that is, via the known and usual procedure. According to this embodiment, the multilayer strip S′/E′ /S″/E″ is made in a “hybrid” way, that is, via cold lamination and hot lamination.

By examining the characteristics of the method and machine 1, the advantages of the present invention are clear.

In particular, the first separator strip 3, S′ and the first electrode strip 3, E′ are cold laminated, but only the first separator strip 3, S′ is heated before such cold lamination. As such, energy consumption is reduced, process control is improved, and a higher lamination speed may be reached with respect to the known processes.

Furthermore, neither protective layers nor a dedicated system are needed to manage such protective layers, resulting in clear cost, dimension, energy, as well as safety savings.

Since the electrodes are not heated, problems due to their thermal expansion are avoided. In particular, the electrodes do not contract, do not tend to bend, and the separator is not subject to stresses, and the multilayer strip does not have concavities which would entail a degradation in end product performance.

The method and machine 1 may also be used for solid-state batteries having non-aqueous electrolytes, in particular embedded in the separator. In fact, the method and machine 1 are especially useful in the case of polymeric separators (or also provided with oxides, sulfurs, or gels) since, by heating the outer polymeric part of the separator, the adhesion to the electrode is facilitated and quick (also possibly allowing lamination pressures to be reduced).

Furthermore, in those cases, the separator does not necessarily need to be coated with ceramic particles, thus it is cheaper, lighter and thinner.

Finally, it is apparent that modifications and variations can be made to the method and machine 1 without departing from the scope of protection defined by the claims.

For example, the described method can be applied iteratively, adding additional electrode and/or separator layers.

1. A method for laminating strips (3) of material, in particular for the production of electrical energy storage devices, the strips (3) comprising at least a first separator strip (3, S′) and at least a first electrode strip (3, E′), the first separator strip (3, S′) comprising a first face (11) and a second face (12), the method comprising the sequential steps of:
a) conveying the first separator strip (3, S′) along a feeding path (A) in a first direction (D, D′);
b) heating at least the first face (11) of the first separator strip (3, S′), the first face (11) of the first separator strip (3, S′) being configured to face a respective face of the first electrode strip (3, E′);
c) introducing the first separator strip (3, S′) and the first electrode strip (3, E′) in a lamination unit (5); and
d) cold laminating, via the lamination unit (5), the first separator strip (3, S′) and the first electrode strip (3, E′) together.

2. The method as claimed in claim 1, wherein the heating step comprises also heating the second face (12) of the first separator strip (3, S′).

3. The method as claimed in claim 1, wherein the heating step is carried out at a temperature between 25° C. and 120° C., in particular between 50° C. and 100° C., preferably between 65° C. and 85° C.

4. The method as claimed in claim 1, wherein the heating step is carried out at a non-zero distance, in particular at a distance greater than 50 mm, preferably less than 1000 mm, and in particular less than 500 mm, preferably between 100 mm and 500 mm, from the lamination unit (5).

5. The method as claimed in claim 1, wherein the strips (3) comprise at least a second separator strip (3, S″) and at least a second electrode strip (3, E″), the second separator strip (3, S″) comprising a first face (21) and a second face (22), the method further comprising the steps of:
e) conveying the second separator strip (3, S″) along a feeding path (A) in a second direction (D, D″);
f) heating the first face (21) of the second separator strip (3, S″), the first face (21) of the second separator strip (3, S″) being configured to face a respective face of the first electrode strip (3, E′);
g) heating the second face (22) of the second separator strip (3, S″), the second face (22) of the second separator strip (3, S″) being configured to face a respective face of the second electrode strip (3, E″); and
h) cold laminating the second separator strip (3, S″) and the second electrode strip (3, E″) together,
wherein the step of heating the first face (21) of the second separator strip (3, S″) is prior to, simultaneous with or subsequent to the step of heating the second face (22) of the second separator strip (3, S″).

6. The method as claimed in claim 5, wherein the step of cold laminating the first separator strip (3, S′) and the first electrode strip (3, E′) together is carried out in a first lamination unit (5, 5′), and the step of cold laminating the second separator strip (3, S″) and the second electrode strip (3, E″) together is carried out in the first lamination unit (5, 5′).

7. The method as claimed in claim 5, wherein the step of cold laminating the first separator strip (3, S′) and the first electrode strip (3, E′) together is carried out in a first lamination unit (5, 5′), and the step of cold laminating the second separator strip (3, S″) and the second electrode strip (3, E″) together is carried out in a second lamination unit (5, 5″) separated from the first lamination unit (5, 5′).

8. The method as claimed in claim 5, further comprising the step of:
i) sequentially cutting the first electrode strip (3, E′) and/or the second electrode strip (3, E″) to determine the sequential separation of successive portions of the first electrode strip (3, E′) and/or the second electrode strip (3, E″), respectively,
wherein said step is prior to the step of cold laminating the first separator strip (3, S′) and the first electrode strip (3, E′) together and/or the step of cold laminating the second separator strip (3, S″) and the second electrode strip (3, E″) together.

9. An automatic machine for laminating strips (3) of material, in particular for the production of electrical energy storage devices, the strips (3) comprising at least a first separator strip (3, S′) and at least a first electrode strip (3, E′), the first separator strip (3, S′) comprising a first face (11) and a second face (12), the machine (1) comprising:
a first conveyor unit (C, C′) configured to convey the first separator strip (3, S′) along a feeding path (A) in a first direction (D, D′);
first heating means (4, 4′) configured to heat at least the first face (11) of the first separator strip (3, S′), the first face (11) of the first separator strip (3, S′) being configured to face a respective face of the first electrode strip (3, E′); and
a first lamination unit (5, 5′) operatively downstream of the first heating means (4, 4′), the first lamination unit (5, 5′) being configured to cold laminate the first separator strip (3, S′) and the first electrode strip (3, E′) together.

10. The machine as claimed in claim 9, wherein the first heating means (4, 4′) are configured to also heat the second face (12) of the first separator strip (3, S′).

11. The machine as claimed in claim 9, the strips (3) comprising at least a second separator strip (3, S″) and at least a second electrode strip (3, E″), the second separator strip (3, S″) comprising a first face (21) and a second face (22), the machine (1) comprising:
a second conveyor unit (C, C″) configured to convey the second separator strip (3, S″) along a feeding path (A) in a second direction (D, D″); and
second heating means (4, 4″) configured to heat the first face (21) of the second separator strip (3, S″), the first face (21) of the second separator strip (3, S″) being configured to face a respective face of the first electrode strip (3, E′), and to heat the second face (22) of the second separator strip (3, S″), the second face (22) of the second separator strip (3, S″) being configured to face a respective face of the second electrode strip (3, E″).

12. The machine as claimed in claim 9, wherein the heating means (4) are selected from the group comprising heating plates, resistance heaters, infrared heaters, microwave heaters, laser heaters, ultrasonic heaters.

13. The machine as claimed in claim 9, wherein the first lamination unit (5, 5′) is configured to cold laminate the first separator strip (3, S′), the first electrode strip (3, E′), the second separator strip (3, S″), the second electrode strip (3, E″) together.

14. The machine as claimed in claim 9, the machine (1) comprising:
a second lamination unit (5, 5″) separated from the first lamination unit (5, 5′), the second lamination unit (5, 5″) being configured to cold laminate the second separator strip (3, S″) and the second electrode strip (3, E″), and the strips (3) previously laminated by the first lamination unit together.

15. The machine as claimed in claim 9, wherein each lamination unit (5) comprises two lamination rollers (31′, 31″) arranged on opposite sides of the feeding path (A), each lamination roller (31′, 31″) comprising a non-stick or easy release coating.

16. The machine as claimed in claim 15, comprising at least one cleaning system (41) of the lamination rollers (31′, 31″).

17. The machine as claimed in claim 16, wherein the at least one cleaning system (41) comprises an elastomeric roller (42) and/or an adhesive roller (43) and/or a cleaning brush (44).
